(19) United States
(12) Patent Application Publication
(10) Pub. No.: US 2019/0235650 A1
(43) Pub. Date: Aug. 1, 2019

(54) DIGITAL STYLUS NIB INCLUDING WEAR INDICATOR

(71) Applicant: HEWLETT-PACKARD DEVELOPMENT COMPANY, LP., Spring, TX (US)

(72) Inventor: David Quijano, Fort Collins, CO (US)

(73) Assignee: HEWLETT-PACKARD DEVELOPMENT COMPANY, LP, Spring, TX (US)

(21) Appl. No.: 16/341,048

(22) PCT Filed: Oct. 11, 2016
(86) PCT No.: PCT/US2016/056442

§ 371 Date: Apr. 10, 2019

(51) Int. Cl. G06F 3/0354; G06F 1/16

(52) U.S. Cl. CPC G06F 3/03545; G06F 1/169

(57) ABSTRACT

In some examples, a digital stylus nib may include a body portion and a tip portion. The tip portion may be disposed at an end of the body portion. The tip portion may include a substrate and a coating on the substrate. The substrate may include a visual indicator.

### BACKGROUND

An electronic device such as a tablet may include a screen that is used to receive input to control various functions of the electronic device. For example, a user may actuate an application stored on the electronic device by inputting a command to the electronic device. The command may be input by using actions such as depressing a location of the screen, using a sliding action across the screen, using an input device to actuate the application, etc.

### BRIEF DESCRIPTION OF DRAWINGS

Features of the present disclosure are illustrated by way of example and not limited in the following figure(s), in which like numerals indicate like elements, in which:

FIG. 1 illustrates an isometric view of a digital stylus nib including a wear indicator, according to an example of the present disclosure;

FIG. 2 illustrates a side view of the digital stylus nib including a wear indicator according to FIG. 1, with the digital stylus nib being disposed in a smart pen, according to an example of the present disclosure;

FIGS. 3A-3C illustrate wear associated with the digital stylus nib including a wear indicator according to FIG. 1, according to an example of the present disclosure;

FIGS. 4A-4C illustrate enlarged views of wear associated with a tip portion of the digital stylus nib including a wear indicator according to FIG. 1, according to an example of the present disclosure; and

FIGS. 5A-5C illustrate isometric views of wear associated with the digital stylus nib including a wear indicator according to FIG. 1, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

A digital stylus nib may include a wear indicator. The disclosed digital stylus nib may include an elongated body portion which may be formed in the shape of a pen. A tip portion may be disposed at an end of the elongated body portion. The tip portion may include a substrate and a coating on the substrate. According to an example, the coating may include felt. When the digital stylus nib is used with a smart pen that includes a camera, the sliding action of the tip portion on a screen surface of an electronic device operates to read a pattern of dots, which may be analyzed to determine a stroke of the smart pen. Alternatively, the digital stylus nib may be used with a smart pen without a camera, or without a smart pen, where the sliding action of the tip portion on a screen surface of an electronic device operates to determine a stroke of the digital stylus nib.

A smart pen as described herein may include any type of pen (or similar device) that is used with an electronic device, such as a tablet, touch-screen phone, computer, etc., to control various functions of the electronic device. For example, the smart pen may be used to actuate an application stored on the electronic device by inputting a command to the electronic device. Alternatively or additionally, the smart pen may be used to write on a screen surface of the electronic device. Alternatively or additionally, the smart pen may be used to write on a surface that includes a specified pattern (e.g., dots) to capture writing or other types of strokes performed on the writing surface. According to an example disclosed herein, the smart pen may include a camera to capture strokes performed on a writing surface. However, the smart pen may be utilized without a camera to capture strokes performed on a screen surface of an electronic device. The smart pen may also include a configuration that provides for the interchangeability of the digital stylus nib with a nib that includes ink. The digital stylus nib disclosed herein may thus be used with or without the smart pen to provide a user with an indication of wear associated with the digital stylus nib.

As the tip portion of the digital stylus nib wears due to use and a flat (or worn) surface forms due to removal of a portion of the coating, the exposed surface may pick up dust and other particles that may scratch the surface of the electronic device and/or result in erroneous reading of the pattern (e.g., dots) on a writing surface. A worn tip portion may also scratch an anti-glare (or another coating) on the surface of the electronic device.

In order to address the aforementioned technical challenges associated with digital stylus nibs, according to an example, the substrate of the digital stylus nib disclosed herein may include a visual indicator to provide a visual perceptual property based indication of wear of the tip portion upon removal of a portion of the coating due to use of the digital stylus nib. The visual perceptual property may represent a color associated with the tip portion. For example, the visual perceptual property of the substrate may include a wavelength selected from a wavelength range of approximately 490 to 800 nm. The visual perceptual property including a wavelength selected from the wavelength range of approximately 490 to 800 nm may provide for amplification of the visual perceptual property associated with the tip portion, for example, in low light conditions that may be associated with use of the digital stylus nib. In this manner, a wear indicator is provided to generate a visual indication to replace the digital stylus nib when a sufficient portion of the coating is removed due to use of the digital stylus nib.

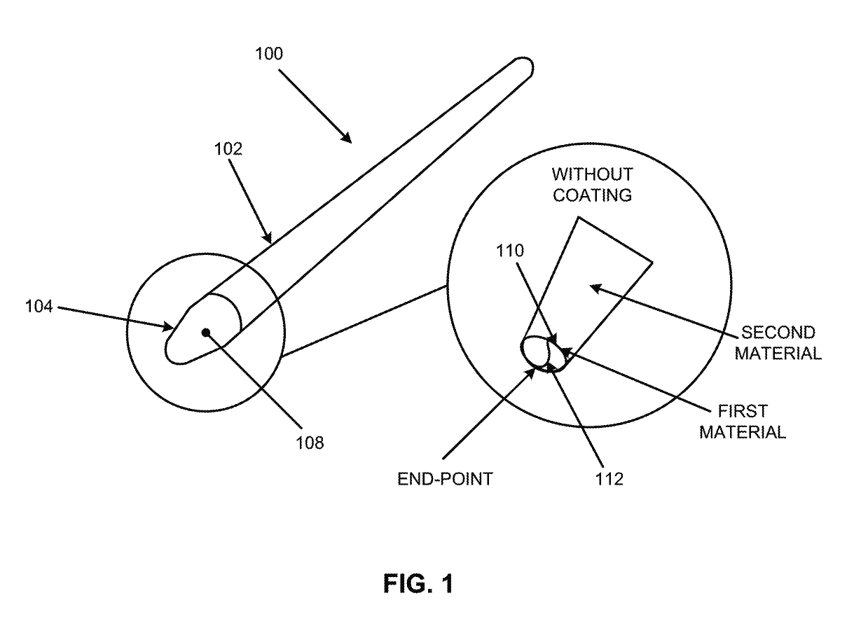

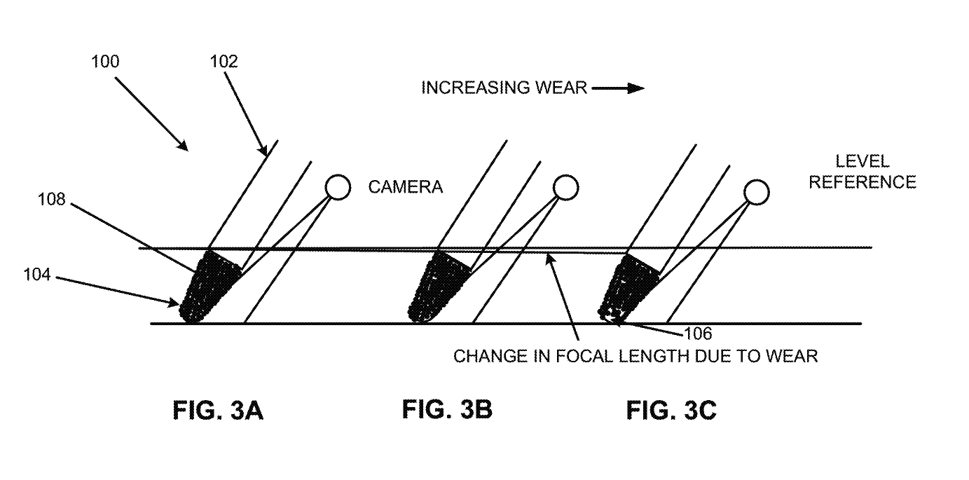

FIG. 1 illustrates an isometric view of a digital stylus nib including a wear indicator (hereinafter “digital stylus nib 100”), according to an example of the present disclosure. FIGS. 3A-3C illustrate wear associated with the digital stylus nib 100, according to an example of the present disclosure

Referring to FIGS. 1 and 3A-3C, the digital stylus nib 100 may include an elongated body portion 102 and a tip portion 104 disposed at an end of the elongated body portion. The tip portion 104 may include a substrate 106 (see FIG. 3C which shows the substrate 106 under a coating 108).

The substrate 106 may be formed of a homogeneous material for the entire tip portion 104. Alternatively, as shown in FIG. 1, the substrate 106 may be formed of a first material towards the end-point of the tip portion 104, and a second material for the remaining tip portion 104. The substrate 106 may be formed of a plastic, ceramic, or another material on which the coating 108 may be applied.

The digital stylus nib 100 may further include a visual indicator 110 to provide a visual perceptual property based indication of wear of the tip portion 104 upon removal of a portion of the coating 108 due to use of the digital stylus nib 100.

According to an example, the coating 108 may include a felt coating. Alternatively, the coating 108 may be made from rubber, plastic, etc., or generally, any soft material.

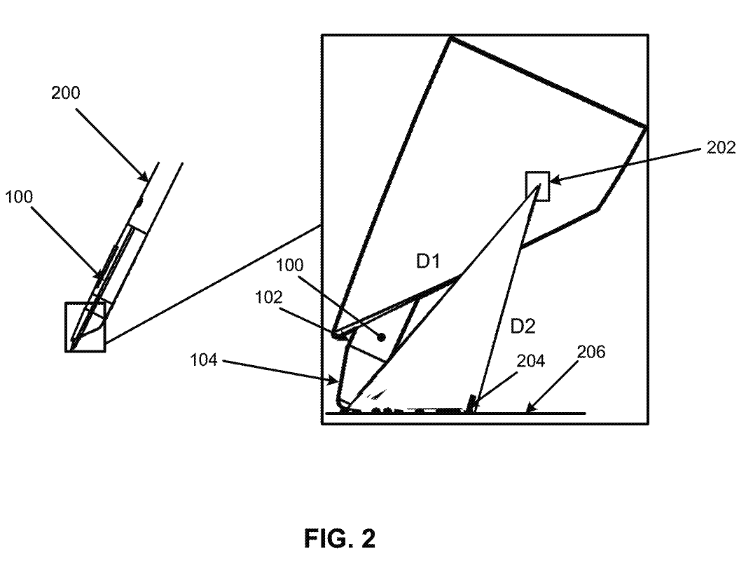

The coating 108 may include a specified thickness to maintain a surface of the substrate 106 at a specified distance from a screen of an electronic device. For example, FIG. 2 illustrates a side view of the digital stylus nib 100, with the digital stylus nib 100 being disposed in a smart pen 200, according to an example of the present disclosure. Referring to FIG. 2, the smart pen 200 may include a camera 202. The camera 202, in conjunction with a light emitting diode (LED), may read a pattern of dots 204 on a screen 206 of an electronic device (or on another surface). When the tip portion 104 crosses the pattern of dots 204, the camera 202 may register the intersections of the dots 204 as a stroke. The distance D1 between the camera 202 (e.g., a calibration point on the camera 202) and an end-point of the tip portion 104, and the distance D2 between the camera 202 and the screen 206 of the electronic device may be specified, or otherwise calibrated, for accuracy of the operation of the smart pen 200. Thus, the coating 108 may include a specified thickness to maintain a surface of the substrate 106 at a specified distance from the screen 206 of the electronic device. Similarly, the coating 108 may include the specified thickness to maintain a specified distance (e.g., the distance D1) from the camera 202 to an end-point of the tip portion 104.

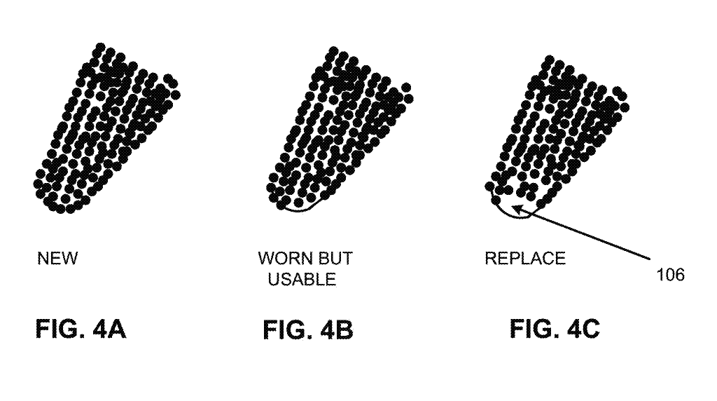

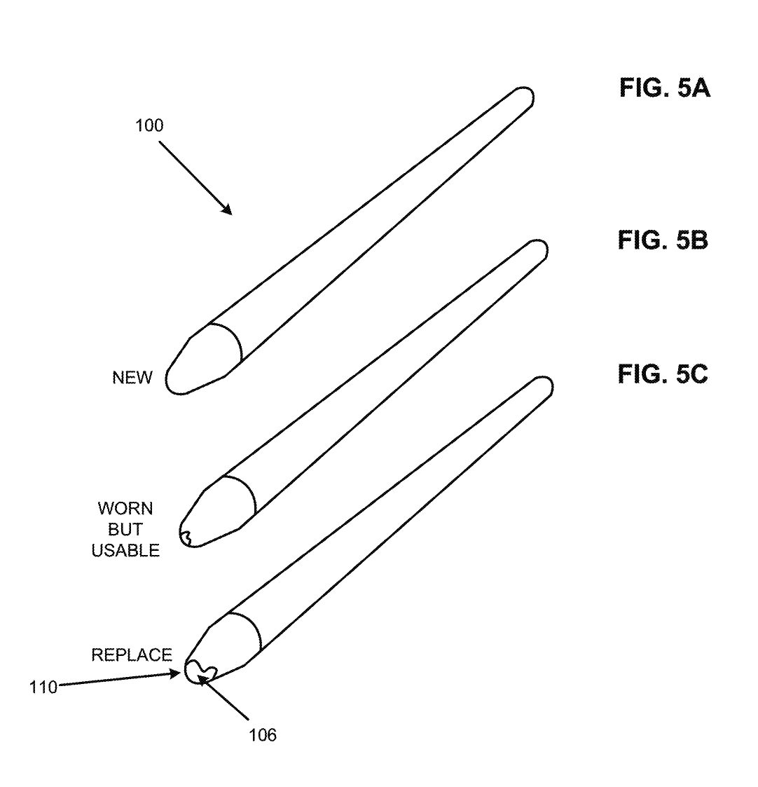

For example, referring to FIGS. 3A-3C, FIG. 3A illustrates the tip portion 104 without any wear (e.g., with all of the coating 108), FIG. 3B illustrates the tip portion 104 including some wear (e.g., with some of the coating 108 removed due to use), and FIG. 3C illustrates a worn tip portion 104 (e.g., with a sufficient portion of the coating 108 removed to cause a change in the focal length of the camera 202). In this regard, FIGS. 4A-4C illustrate enlarged views of wear associated with the tip portion 104, and FIGS. 5A-5C illustrate isometric views of wear associated with the tip portion 104, according to an example of the present disclosure. The wear associated with the tip portion 104 for FIGS. 3A-3C respectively correspond to the wear associated with the tip portion 104 for FIGS. 4A-4C, and FIGS. 5A-5C. In this regard, the coating 108 may include a specified thickness to maintain a surface of the substrate 106 at a specified distance from the screen 206 of the electronic device, and to thus avoid a change in the focal length of the camera 202. Similarly, the coating 108 may include the specified thickness to maintain a specified distance (e.g., the distance D1) from the camera 202 to an end-point of the tip portion 104, and to thus avoid a change in the focal length of the camera 202.

Referring again to FIGS. 1 and 3A-3C, the visual indicator 110 may include a visual perceptual property that is substantially different from a visual perceptual property of the coating 108 to provide the indication of the wear of the tip portion 104. The visual perceptual property may represent a color associated with the tip portion 104. For example, the visual perceptual property may include a difference in hue, saturation, value, lightness, and/or brightness in a hue, saturation, and luminosity (HSL) or hue, saturation, and value (HSV) model. The color may be selected by choosing colors having at least a predetermined distance between points on an HSL/HSV cylinder, at least a predetermined distance between points on a red, green, blue (RGB) cube, at least a predetermined distance between points in an International Commission on Illumination (CIE) color space, or the like. The visual perceptual property may also represent other properties associated with the tip portion 104. For example, the other properties may include fluorescence properties, properties under which the visual indicator 110 is activated based on the application of a light source (e.g., ultraviolet light, etc.), a chemical, etc., to display, or to amplify the visual perceptual property associated with the visual indicator 110.

According to an example, the visual indicator 110 may include a layer 112 on the substrate 106 (e.g., FIG. 1 illustrates the layer 112 partially removed to expose the underlying surface or any other layer below the layer 112). For example, the layer 112 on the substrate 106 may be formed by depositing a material on the substrate 106. The layer 112 may include a visual perceptual property including a wavelength selected from a wavelength range of approximately 490 to 800 nm. The wavelength range of approximately 490 to 800 nm corresponds to colors that include green, yellow, orange, and red. For example, for the coating 108 that includes a visual perceptual property corresponding to a black or gray color, the layer 112 may include a visual perceptual property corresponding to a wavelength between a range of approximately 650-800 nm, which corresponds to a red color.

According to another example, the layer 112 and/or the substrate 106 may absorb different wavelengths. For example, absorbing green may create a magenta, which may contrast with a material that absorbs red thereby creating cyan.

According to another example, the visual indicator 110 may include a first layer (e.g., the layer 112) on the substrate 106. The first layer 112 may include a visual perceptual property including a wavelength selected from a wavelength range of approximately 490 to 800 nm. The visual indicator 110 may include a second layer (e.g., a layer below the first layer) on the substrate 106. The second layer may include a visual perceptual property including a wavelength selected from the wavelength range of approximately 490 to 800 nm. The wavelength of the visual perceptual property of the second layer may be different from the wavelength of the visual perceptual property of the first layer. For example, for the coating 108 that includes a visual perceptual property corresponding to a black or gray color, the wavelength of the visual perceptual property of the first layer may be between a range of approximately 490-530 nm, which corresponds to a green color, and the wavelength of the visual perceptual property of the second layer may be between a range of approximately 650-800 nm, which corresponds to a red color. Accordingly, wear associated with the tip portion 104 upon removal of a portion of the coating 108 due to use of the digital stylus nib 100 may provide a user of the digital stylus nib 100 with a first indication (e.g., warning) of the impending need to replace the digital stylus nib 100. For example, when the user of the digital stylus nib 100 is able to visually see the first layer that includes a visual perceptual property in a range of approximately 490-530 nm, the user may thus ascertain the first indication (e.g., warning) of the impending need to replace the digital stylus nib 100. Further, when the user of the digital stylus nib 100 is able to visually see the second layer that includes a visual perceptual property in a range of approximately 650-800 nm, the user may thus ascertain the affirmative need to replace the digital stylus nib 100, without any further use of the digital stylus nib 100.

According to an example, the visual indicator 110 may include a plurality of layers (e.g., a first layer, a second layer, a third layer, etc., below the first layer) on the substrate 106. Additionally or alternatively, the visual indicator 110 may include the substrate 106 formed of a plurality of layers (e.g., a first layer, a second layer, a third layer). In this manner, the visual indicator 110 may provide a multi-tiered wear indication associated with the tip portion 104. For example, the multi-tiered wear indication may correspond to different wear characteristics and/or uses of the digital stylus nib 100. For example, a first wear indication may be associated with use of the digital stylus nib 100 with an electronic device, a second wear indication may be associated with use of the digital stylus nib 100 with another type of electronic device or another type of surface, etc.

According to an example, a material of a specified visual perceptual property may be used to form the substrate 106. The material may include a visual perceptual property including a wavelength selected from the wavelength range of approximately 490 to 800 nm. The wavelength of the visual perceptual property of the material may be different from the wavelength of the visual perceptual property of the first layer (e.g., the layer 112). For example, the wavelength of the visual perceptual property of the first layer may be between a range of approximately 490-530 nm, which corresponds to a green color, and the wavelength of the visual perceptual property of the material used to form the substrate 106 may be between a range of approximately 650-800 nm, which corresponds to a red color. Accordingly, wear associated with the tip portion 104 upon removal of a portion of the coating 108 due to use of the digital stylus nib 100 may provide a user of the digital stylus nib 100 with a first indication (e.g., warning) of the impending need to replace the digital stylus nib 100. For example, when the user of the digital stylus nib 100 is able to visually see the first layer that includes a visual perceptual property in a range of approximately 490-530 nm, the user may thus ascertain the first indication (e.g., warning) of the impending need to replace the digital stylus nib 100. Further, when the user of the digital stylus nib 100 is able to visually see the substrate 106 that includes a visual perceptual property in a range of approximately 650-800 nm, the user may thus ascertain the affirmative need to replace the digital stylus nib 100, without any further use of the digital stylus nib 100.

According to an example, the visual indicator 110 may include a pattern that is substantially different from a pattern of the coating 108 to provide the wear and/or replacement indication for the digital stylus nib 100. For example, the coating 108 may include a spotted pattern as shown in FIGS. 3A-3C, whereas the visual indicator 110 may include a cross-hatched (or another type of pattern) pattern to provide the replacement indication for the digital stylus nib 100. The pattern of the visual indicator 110 may be formed by deposit of a layer (e.g., the layer 112) onto the substrate 106 and/or formation of the substrate 106 to include the pattern. Accordingly, once the visual indicator 110 is exposed as shown in FIGS. 3C and 4C, the pattern of the visual indicator 110 may be exposed to provide the wear and/or replacement indication for the digital stylus nib 100.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A digital stylus nib comprising:
an elongated body portion; and
a tip portion disposed at an end of the elongated body portion, wherein
the tip portion includes a substrate and a coating on the substrate, and
the substrate includes a visual indicator to provide a visual perceptual property based indication of wear of the tip portion upon removal of a portion of the coating due to use of the digital stylus nib.

2. The digital stylus nib according to claim 1, wherein the coating includes a felt coating.

3. The digital stylus nib according to claim 2, wherein the felt coating includes a specified thickness to maintain a surface of the substrate at a specified distance from a screen of an electronic device.

4. The digital stylus nib according to claim 1, wherein
the visual indicator includes a layer on the substrate, and
the layer includes a visual perceptual property including a wavelength selected from a wavelength range of approximately 490 to 800 nm.

5. The digital stylus nib according to claim 1, wherein the visual indicator includes
a first layer on the substrate, the first layer includes a visual perceptual property including a wavelength selected from a wavelength range of approximately 490 to 800 nm, and
a second layer on the substrate, the second layer includes a visual perceptual property including a wavelength selected from the wavelength range of approximately 490 to 800 nm, wherein the wavelength of the visual perceptual property of the second layer is different from the wavelength of the visual perceptual property of the first layer, or
a material used to form the substrate, the material includes a visual perceptual property including a wavelength selected from the wavelength range of approximately 490 to 800 nm, wherein the wavelength of the visual perceptual property of the material is different from the wavelength of the visual perceptual property of the first layer.

6. The digital stylus nib according to claim 1, wherein
the visual indicator includes material used to form the substrate, and
the material includes a visual perceptual property including a wavelength selected from a wavelength range of approximately 490 to 800 nm.

7. A digital stylus nib comprising:
an elongated body portion disposable in a smart pen including a camera; and
a tip portion disposed at an end of the elongated body portion, wherein
the tip portion includes a substrate and a coating on the substrate,
the coating includes a specified thickness to maintain a specified distance from the camera to an end-point of the tip portion, and
the substrate includes a visual indicator to provide an indication of wear of the tip portion.

8. The digital stylus nib according to claim 7, wherein the coating includes the specified thickness to maintain a surface of the substrate at another specified distance from a screen of an electronic device.

9. The digital stylus nib according to claim 7, wherein the visual indicator includes a visual perceptual property that is substantially different from a visual perceptual property of the coating to provide the indication of the wear of the tip portion.

10. The digital stylus nib according to claim 7, wherein the visual indicator includes a pattern that is substantially different from a pattern of the coating to provide the indication of the wear of the tip portion.

11. A digital stylus nib comprising:
a body portion; and
a tip portion disposed at an end of the body portion, wherein
the tip portion includes a substrate and a coating on the substrate,
the coating includes a specified thickness to maintain a surface of the substrate at a specified distance from a screen of an electronic device, and
the substrate includes a visual indicator to provide a replacement indication for the digital stylus nib.

12. The digital stylus nib according to claim 11, wherein
the visual indicator includes material used to form the substrate, and
the material includes a visual perceptual property including a wavelength selected from a wavelength range of approximately 490 to 800 nm.

13. The digital stylus nib according to claim 11, wherein
the body portion is disposable in a smart pen including a camera, and
the coating includes the specified thickness to maintain another specified distance from the camera to an end-point of the tip portion.

14. The digital stylus nib according to claim 11, wherein the visual indicator includes a visual perceptual property that is substantially different from a visual perceptual property of the coating to provide the replacement indication for the digital stylus nib.

15. The digital stylus nib according to claim 11, wherein the visual indicator includes a pattern that is substantially different from a pattern of the coating to provide the replacement indication for the digital stylus nib.
